(19) United States
(12) Patent Application Publication
(10) Pub. No.: US 2010/0332028 A1
(43) Pub. Date: Dec. 30, 2010

(54) RADIOFREQUENCY DISPENSING OF ELECTRONIC TICKETS

(75) Inventors: Eric Hilpipre, Languex (FR); Pascal Roudier, La Bedoule (FR)

Correspondence Address: SUGHRUE MION, PLLC, 2100 PENNSYLVANIA AVENUE, N.W., SUITE 800, WASHINGTON, DC, 20037, US

(73) Assignee: Mobilysim, Meyreuil (FR)

(21) Appl. No.: 12/810,588

(22) PCT Filed: Dec. 28, 2007
(86) PCT No.: PCT/FR2007/002182

§ 371 Date: Aug. 25, 2010

(51) Int. Cl. G06F 17/00; H04M 1/00

(52) U.S. Cl. 700/237; 455/556.1

(57) ABSTRACT

The invention relates to an electronic ticket dispenser system, the system comprising: a dispenser terminal (3) comprising first communications means adapted to a first RF protocol to transmit a dedicated ticket in response to a validation command; a processor platform (6) for processing said tickets; connection means (5) between said dispenser terminal (3) and said processor platform (6); a computer application enabling authenticated communication between said dispenser terminal and said processor platform; and an acquisition mobile terminal (4) comprising means adapted to said first RF protocol and means for storing data (8) identifying and authenticating said dedicated ticket. In addition, the validation command appears on said dispenser terminal (3). The invention also provides a dispenser terminal as set out above and a method of dispensing electronic tickets.

The present invention relates to radiofrequency (RF) dispensing of electronic tickets for authorizing access to given products or services, the tickets being dispensed by a dispenser terminal to an acquisition terminal. The dispenser terminal may for example be a specific near-field communication (NFC) mobile telephone. The acquisition terminal is a contactless RF connection device, e.g. a radiofrequency identification (RFID) chip card or some other NFC compatible mobile telephone.

Electronic tickets are purchased by a user from a distributor. During a transaction, the data of the electronic ticket in question is transmitted via the dispenser terminal to the acquisition terminal.

Nowadays, contactless applications using RFID and NFC technologies are being developed more and more. The standardization of these technologies has led to various standards, defined in particular by the following standards: ISO 14443 A and B, ISO 15693, and ISO 18092. The European ICARE and then CALYPSO projects demonstrate the extent to which the utilization of contactless technologies is developing, in particular in the field of public transport.

An electronic ticket, that has been dispensed contactlessly contains data serving to identify and/or authenticate the ticket; said data is stored digitally, possibly in encrypted form, in a memory incorporated in an RF chip or in a memory associated therewith. Dispensed electronic tickets give access to a product or to a service requiring an access right, and by way of example and in non-limiting manner they may be: travel tickets such as season tickets or bus and metro tickets; a package ticket giving access to the ski lifts in a ski resort; tickets for shows, museums, or sports events; “refill” tickets for prepaid mobile telephones; or meal vouchers.

With reference to FIG. 2, when an electronic ticket is used, the user 2 brings an acquisition terminal 4 up to an RF access base 10 capable of reading from, and possibly also of writing to, the RF chip. The ticket data 8 is read, and identification and/or authentication thereof with verification of validity serves to authorize or refuse access to the product or to the service.

The user of an electronic ticket has an acquisition terminal, an RF chip card in the present example, or a mobile telephone with an NFC chip operating with the same RF standards and capable of emulating an RFID card. The electronic ticket dispenser uses a dispenser terminal capable of reading and writing information in the acquisition terminal using an RF channel. Present dispenser systems use as the dispenser terminal either a dedicated specific terminal, or else an RF peripheral coupled to an electronic payment terminal (EPT) or to a point-of-sale (POS) terminal. Such specific equipment is relatively expensive and generally requires fixed infrastructure for electrical power supply and connection to telecommunications networks.

The system and the method of the invention make it possible to dispense electronic tickets using contactless technologies, advantageously taking the place of present dispenser devices, by means of consumer mobile equipment such as NFC mobile telephones, which equipment is compact, capable of reading and writing via contactless chips, and of communicating via mobile telephone networks with a computer platform that manages products and the dispensing system, thereby reducing presently-existing fixed infrastructure constraints and systems costs. When the personal telephone of a potential distributor is NFC compatible in reading and writing, the problem of the cost of a dispenser terminal no longer arises, and a computer application loaded in the personal telephone enables said telephone to be used as a dispenser terminal.

According to the invention, an electronic ticket dispenser system comprises:
a dispenser terminal comprising first communications means adapted to a first RF protocol to transmit a dedicated ticket in response to a validation command;
a processor platform for processing the tickets;
connection means between the dispenser terminal and the processor platform;
a computer application enabling authenticated communication between the dispenser terminal and the processor platform; and
an acquisition mobile terminal comprising means adapted to the first RF protocol and means for storing data identifying and authenticating the dedicated ticket.

Furthermore, the validation command appears on the dispenser terminal.

Advantageously, the connection means pass via a radiocommunications network.

Preferably, the dispenser terminal is a mobile telephone having means for emulating the first communications means that are compatible with the transmission means of the acquisition terminal.

Likewise, the dispenser terminal includes means for emulating at least one second communications means adapted to a second RF protocol.

Under such circumstances, the acquisition mobile terminal includes transmission means adapted to the second RF protocol.

The invention also provides a dispenser terminal for dispensing electronic tickets, the terminal comprising first communications means adapted to a first RF protocol for transmitting a dedicated ticket in response to a validation command, the dispenser terminal being connected via connection means to a ticket processor platform, a computer application enabling authenticated communication to take place between the dispenser terminal and the processor platform, the dedicated ticket being destined for an acquisition mobile terminal that includes transmission means adapted to the first RF protocol and means for storing data identifying and authenticating the dedicated ticket; the dispenser terminal includes means for producing the validation command.

The invention also provides a method of dispensing electronic tickets, the method comprising:
a connection step for initiating a transaction involving at least one dedicated ticket, the connection being between a dispenser terminal and a processor platform;
a verification step for managing authentication and authorization of the transaction;
a validation step for authorizing a delivery step; and
a delivery step for transmitting data identifying the dedicated ticket from the dispenser terminal to an acquisition terminal;
   the validation step is performed by means of the dispenser terminal.

Optionally, the transaction involves a plurality of tickets.

The present invention appears below in greater detail in the context of the following description of embodiments given by way of illustration and with reference to the accompanying figures, in which:

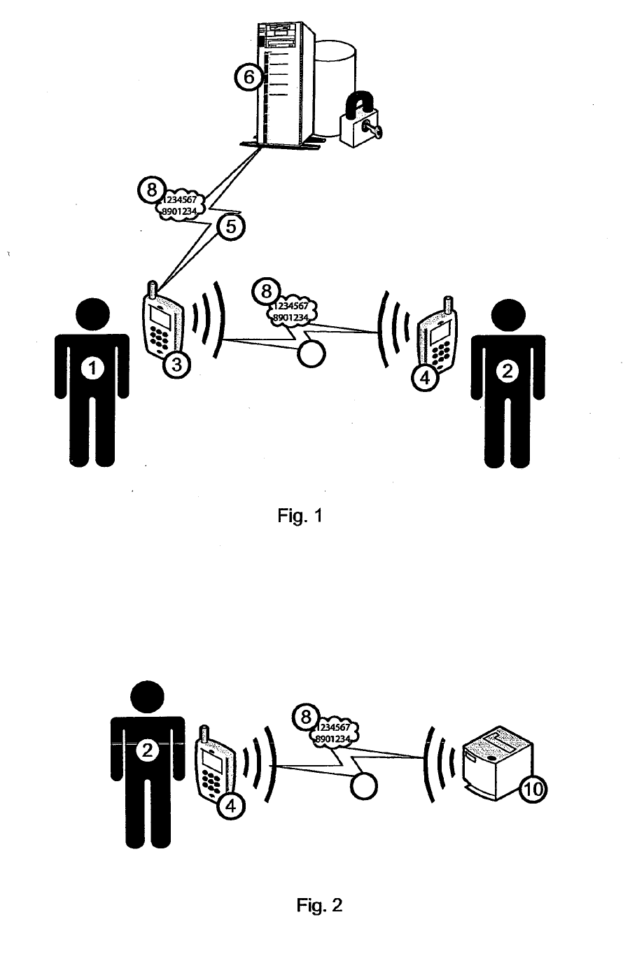

FIG. 1 is a symbolic diagram of an operation of acquiring an electronic ticket; and

FIG. 2 is a symbolic diagram of an operation of using such a ticket.

Elements present in both figures are given the same references in each of them.

With reference to FIG. 1, the system of the invention is constituted by a ticket-processor computer platform 6 and by dispenser terminals represented by a single NFC mobile telephone 3 capable of emulating an RF terminal. Certain NFC chips can enable a compatible mobile telephone to emulate the functions of an RF terminal for the purposes of reading, transmitting, and writing electronic ticket data in a card operating with the RFID protocol or in an NFC telephone. The system also has numerous acquisition terminals represented by a single RF device 4 operating with the same protocol and thus making it possible to store and to transmit data 8 identifying and/or authenticating a ticket giving access to goods or services.

Naturally, it may be envisaged that the dispenser terminal and/or the acquisition terminal are capable of communicating in a plurality of RF protocols. This point is not described in greater detail since it forms part of the general knowledge of the person skilled in the art.

The computer platform 6 hosts application servers for managing storage and delivery of electronic tickets, processes for identifying distributors, and possibly for billing. The central platform accesses and is accessible from the mobile telephone network 5, either directly or via fixed connections, to and from which the operator of said connections can set up calls with the mobile network. Said fixed connections may in particular comprise an access to the public switched telephone network, to ADSL, or to a specialized line of the “transfix” or the “frame relay” type.

The dispenser terminals 3 are present at the dispenser points. These terminals are thus telephones fitted with an NFC chip capable of emulating an RF terminal in one or more RF standards, and in particular ISO 14443 and ISO 15693. An application that enables communication to take place with the computer platform 6, transactions to be managed, and stocks to be dispensed is loaded into these mobile telephones and as non-limiting examples, mention may be made of: Javacard in a subscriber identity module (SIM) or a universal subscriber identity module (USIM) card; and Java 2 micro edition (J2ME) in the internal memory of the telephone or in an added memory card, of the SD card or equivalent type. Such NFC mobile telephones may be replaced by smart phones or by personal digital assistants (PDAs) having the same functions in terms of mobile communications and NFC. The mobile network protocols used may, for example, be any of the following: WiFi, GMS, CDMA, GPRS, EDGE, SMS, USSD, or UMTS.

The acquisition terminals 4 are smart cards without RFID contact, NFC mobile telephones, or any other existing or future medium containing an RF device capable of storing and communicating data.

A ticket is thus acquired as follows. The user 2 goes to a distributor 1 who verifies that the condition(s) required for implementing the transaction are indeed satisfied, and in particular, for example, that the ticket has been paid for. After which, the distributor validates the present transaction by means of the distributor's dispenser terminal. This validation causes the ticket to be transmitted to the user's acquisition terminal.

Although numerous solutions are possible, this validation may be performed in particular by the following process.

The process of identifying and/or authenticating the distributor 1 may be performed by inputting an identifier and a password via the NFC telephone and/or recovering data identifying the dispenser terminal 3 such as the international mobile equipment identity (IMEI) or data identifying the associated SIM or USIM card, such as the international mobile subscriber identity (IMSI), this data being transmitted to the central platform 6 and then verified and authenticated by said platform prior to authorizing continuation of a transaction.

In a first version of the method, dispensing may be performed in connected mode, the distributor's mobile telephone 3 being connected for each transaction to the computer platform 6 in order to obtain pertinent data 8.

In a second version of the method, the distributor's mobile telephone 3 is connected to the computer platform 6 in order to store in its memory a stock of tickets that it can subsequently dispense without any need to reconnect with the platform.

The system and the method of the invention may enable the distributor's telephone 3 to dispense other prepaid products and tickets in other forms such as, for example SMSs, MMSs, or tickets printed by means of a printer connected to the dispenser telephone, e.g. via a Bluetooth connection. By way of example, these products may be refills for a prepaid mobile telephone, fuel vouchers, gift vouchers for department stores, refills for a satellite TV terminal, etc.

The embodiments of the invention described above are selected because of their concrete nature. Nevertheless, it is not possible to list exhaustively all embodiments covered by the invention. In particular, any means described herein may be replaced by equivalent means without thereby going beyond the ambit of the present invention.

1. An electronic ticket dispenser system, the system comprising:
a dispenser terminal (3) comprising first communications means adapted to a first RF protocol to transmit a dedicated ticket in response to a validation command;
a processor platform (6) for processing said tickets;
connection means (5) between said dispenser terminal (3) and said processor platform (6);
a computer application enabling authenticated communication between said dispenser terminal and said processor platform; and
an acquisition mobile terminal (4) comprising means adapted to said first RF protocol and means for storing data (8) identifying and authenticating said dedicated ticket;
the system being characterized in that said validation command appears on said dispenser terminal (3).

2. A system according to claim 1, characterized in that said connection means (5) pass via a radiocommunications network.

3. A system according to claim 2, characterized in that said dispenser terminal (3) is a mobile telephone having means for emulating said first communications means that are compatible with the transmission means of said acquisition terminal (4).

4. A system according to claim 3, characterized in that said dispenser terminal (3) includes means for emulating at least one second communications means adapted to a second RF protocol.

5. A system according to claim 4, characterized in that said acquisition mobile terminal (4) includes transmission means adapted to said second RF protocol.

6. A dispenser terminal (3) for dispensing electronic tickets, the terminal comprising first communications means adapted to a first RF protocol for transmitting a dedicated ticket in response to a validation command, the dispenser terminal being connected via connection means to a ticket processor platform (6), a computer application enabling authenticated communication to take place between said dispenser terminal and said processor platform, said dedicated ticket being destined for an acquisition mobile terminal (4) that includes transmission means adapted to said first RF protocol and means for storing data (8) identifying and authenticating said dedicated ticket, the terminal being characterized in that it includes means for producing said validation command.

7. A terminal according to claim 6, characterized in that said connection means (5) pass via a radiocommunications network.

8. A terminal according to claim 7, characterized in that it consists in a mobile telephone having means for emulating said first communications means that are compatible with the transmission means of said acquisition terminal (4).

9. A terminal according to claim 8, characterized in that it includes means for emulating at least one second communications means adapted to a second RF protocol.

10. A method of dispensing electronic tickets, the method comprising:
a connection step for initiating a transaction involving at least one dedicated ticket, the connection being between a dispenser terminal (3) and a processor platform (6);
a verification step for managing authentication and authorization of the transaction;
a validation step for authorizing a delivery step; and
a delivery step for transmitting data (8) identifying the dedicated ticket from said dispenser terminal to an acquisition terminal (4);
the method being characterized in that said validation step is performed by means of said dispenser terminal.

11. A method according to claim 10, characterized in that the connection between said dispenser and acquisition terminals (3, 4) is an RF connection.

12. A method according to claim 10, characterized in that said transaction involves a plurality of tickets.
